(19) United States
(12) Patent Application Publication
(10) Pub. No.: US 2024/0249290 A1
(43) Pub. Date: Jul. 25, 2024

(54) Global Trade/Finance Management System Based On Blockchain Technology

(71) Applicant: The Pay Company AG, Zug (CH)

(72) Inventors: Bishoy Mikhael, Newark, CA (US); Khaled Al-Sharif, San Jose, CA (US)

(21) Appl. No.: 18/420,419

(22) Filed: Jan. 23, 2024

Related U.S. Application Data
(60) Provisional application No. 63/441,107, filed on Jan. 25, 2023.

(51) Int. Cl. G06Q 20/40; G06Q 20/36; G06Q 20/38

(52) U.S. Cl. CPC G06Q 20/405; G06Q 20/3678; G06Q 20/3825; G06Q 20/389; G06Q 20/40145

(57) ABSTRACT

Techniques are disclosed for a trade finance system that in its most general form may be used as a general-purpose multi-currency money remittance/transfer platform. A highly relevant use-case of the present platform is for performing letter of credit (LC) transactions. Each transaction object, whether it is a general-purpose transaction object or an LC object, is stored in a decentralized and immutable ledger throughout its lifecycle. The platform facilitates payment from a sender/shipper a buyer/recipient. The funds associated with a transaction are released from escrow/custody once the requirements/terms and documents as specified for/in the transaction are satisfied. For this purpose, an artificial intelligence (AI) module is used to review/analyze the contents of uploaded documents and to verify whether the escrow conditions have been met.

### RELATED APPLICATIONS

This application claims priority from U.S. Provisional Patent Application No. 63/441,107 filed on Jan. 25, 2023 and which is incorporated by reference herein for all purposes in its entirety.

### FIELD OF THE INVENTION

This invention generally relates to the field of multicurrency escrow payments and more specifically to streamlining Letter of Credit (LC) transactions based on Blockchain and Artificial Intelligence (AI) technologies.

### BACKGROUND

Trade transactions involve the sale of goods or services from a seller to a buyer. Financial intermediaries such as banks and other financial institutions facilitate these transactions by financing the trade. A letter of credit (“LC”) is an example of a trade finance service that is used to facilitate trade transactions, such as international trade transactions.

An LC is a document generated by an issuing bank that assures that a seller will receive payment up to a certain amount, as long as certain conditions have been met by the seller. If a buyer is unable to make payment to the seller (and those conditions have been met), the LC allows the seller to demand payment from the bank. In response, the bank is required to cover the remaining amount owed to the seller. Thus, LCs substitute the buyer's credit for the bank's credit, allowing the bank to act as an intermediary between the buyer and the seller.

Traditionally, LCs are paper-based, requiring manual review of the documents. Current LC management systems also lack the capability for buyers and sellers to obtain real-time status information or tracking data. Accordingly, they lack security, transparency, and access capabilities.

There is plenty of prior art that tries to address the difficulties of traditional LC systems, some by utilizing the Blockchain technology. U.S. Patent Publication No. 2023/0015846 A1 to Toffey et al. discloses methods and systems for a trade finance digital asset platform that generally provides improved visibility, security, and workflow execution for a set of trade finance transactions. It enables capabilities for trade finance asset digitization, trade finance data object model and interfaces to systems used by parties to trade finance transactions. It also provides event and state reporting services and smart contract services that optionally operate using a blockchain.

U.S. Patent Publication No. 2018/0268479 A1 to Dowling et al. discloses a method for generating a blockchain-based letter of credit (“BLC”) relating to a contract for a trade transaction between a seller and a buyer. The BLC defines documentary and supply chain flow payment trigger events. The BLC is stored and accessible via a blockchain. A plurality of documentary flow events related to the BLC are tracked and recorded on the blockchain, and are linked to the BLC. A plurality of supply chain flow events related to a physical status of a good involved in the trade transaction are tracked and recorded on the blockchain. Each of the plurality of supply chain flow events are linked to the BLC. Payment for the contract for the trade transaction is transferred to the seller in response to detecting occurrences of both of the documentary and supply chain flow events corresponding to the respective documentary and supply chain flow payment trigger events.

U.S. Patent Publication No. 2023/0186300 A1 to Collins et al. teaches a method for facilitating a payment transaction between incompatible and unconnected payment networks. The method includes receiving, by a receiver of a processing server, a transaction request from a first computing device, the transaction request including at least a first payment network identifier and a second payment network identifier. It also includes identifying, by a processor of the processing server, a first network profile associated with a first payment network based on the first payment network identifier and a second network profile associated with a second payment network based on the second payment network identifier. The method further includes determining, by the processor of the processing server, one or more incremental data values required for the second payment network based on a comparison of the first network profile with the second network profile. The method also includes transmitting, by a transmitter of the processing server, the one or more incremental data values to the first computing device.

U.S. Pat. No. 10,026,082 B2 to Davis teaches a method for managing fractional reserves of blockchain currency. The method includes storing, in a first central account, a fiat amount associated with a fiat currency. The method also includes storing, in a second central account, a blockchain amount associated with a blockchain currency. The method also includes storing a plurality of account profiles, each profile including a fiat currency amount, blockchain currency amount, account identifier, and address. The method further includes receiving a transaction message associated with a payment transaction, the message being formatted based on one or more standards and including a plurality of data elements, including a data element reserved for private use including a specific address and a transaction amount. The method includes identifying a specific account profile that includes the specific address included in the data element in the received transaction message. The method also includes updating the blockchain currency amount included in the identified specific account profile based on the transaction amount included in the data element in the received transaction message.

Despite the abundance of prior art, there are no teachings in the prevailing art for using blockchain and AI technologies in a manner that secures and streamlines the entire LC transaction. The prior art is also silent about using these technologies to provide real-time access to the parties involved in the transaction. Further, there are no teachings in the prior art that use AI to automatically review the LC document and to check their compliance with the LC terms and conditions (Ts&Cs). There are also no teachings in the prior art for tamper-proofing trade-related documents as they are stored in the blockchain.

### OBJECTS OF THE INVENTION

In view of the shortcomings of the prior art, it is an object of the invention to provide techniques for a global trade management/finance platform that benefits letter of credit (LC) transactions with innovative use of blockchain and artificial intelligence (AI) technologies.

It is also an object of the invention to store transaction and LC objects in a distributed and immutable ledger.

It is also an object of the invention to provide a general-purpose multi-currency money transfer/remittance platform.

It is further an object of the invention to act as a financial intermediary for money remittance/transfer transactions.

It is also an object of the invention to only release funds through the platform once the escrow conditions have been satisfied.

It is further an object of the invention to use AI to analyze the various documents needed to meet the requirements of a transaction.

It is also an object of the invention to provide non-custodial and custodial wallets in support of transactions carried out through the instant platform.

Still other objects and advantages of the invention will become apparent upon reading the summary and the detailed description in conjunction with the drawing figures.

### SUMMARY OF THE INVENTION

A number of objects and advantages of the invention are achieved by apparatus and methods for a trade finance or trade management platform that innovatively utilizes blockchain and artificial intelligence (AI) technologies. In its most general form, the system may be used as a general-purpose, multi-currency money remittance or transfer platform between a sender and a recipient. However, a highly advantageous use-case of the present technology is for transacting a letter of credit (LC) between a buyer and a shipper.

There is a decentralized/distributed and immutable ledger in which a transaction object or an LC object of a given transaction is stored and maintained throughout its lifecycle. The transaction/LC object contains the requirements and terms and conditions (Ts&Cs) that are required of each party in the transaction. These conditions may also be thought of and referred to as the escrow conditions that must be fulfilled before funds are released to the recipient or shipper. The distributed ledger is accompanied by a data storage and provides visibility to various stakeholders in a transparent and secure manner.

During a given transaction, there are a number of documents that may be uploaded into the system as per the requirements of the transaction specified in the transaction/LC object. These documents may be uploaded either by the sender/buyer or the recipient/shipper or both. These documents associated with a given transaction are uploaded into the computer system and stored in its distributed ledger introduced above. In the preferred embodiment, the documents are made tamper-proof by employment digital signatures. More specifically, each protected document is stored in the ledger along with its cryptographic hash. When the document is subsequently accessed, its hash is recomputed and matched against the stored version. A match verifies the integrity of the document and vice-versa.

There is further an artificial intelligence (AI) module or assistant or agent. The AI module reviews and analyzes the number, type and contents of the documents uploaded with the transaction, and checks their compliance with the requirements/Ts&Cs of the transaction. Once all the requirements of a transaction are satisfied, this signifies that the requisite payment from the sender/buyer to the recipient/shipper can be made. For this purpose, the instant platform and/or its owning entity is used as the financial intermediary.

To facilitate payment, there is a non-custodial digital wallet for each onboarded user implemented in the system. The respective user has full access to their non-custodial wallet which is used to hold their funds. There is also an escrow or a custodial wallet that is created for each transaction. The custodial/escrow wallet allows the instant platform to segregate funds and to “hold” funds in escrow or custody on behalf of the recipient/shipper until all the escrow conditions of the transactions are satisfied. The platform supports various forms of payments including payment by a sender/buyer in various fiat and cryptocurrencies as well as receipt by a recipient/shipper in various fiat and cryptocurrencies.

The most preferred embodiment utilizes blockchain technology for its distributed ledger. However, the present principles admit of other types of distributed ledgers besides blockchain. The AI module preferably utilized natural language processing (NLP) and large language models (LLMs) among other techniques. Once the AI module has determined a required document to be satisfactory in its contents, the document is marked as Complete. Otherwise, it is marked as Pending.

In the preferred embodiment both the sender/buyer and recipient/shipper are onboarded users of the platform. However, having the recipient/shipper as an onboarded user is not a requirement. In such a scenario, the payment is made to an international bank account number (IBAN) of the recipient/shipper. A user is required to undergo know-your-business (KYB) and/or know-your-customer (KYC) checks before they are onboarded to the platform. Preferably, these checks are outsourced to specialized service providers. In another preferred embodiment, the users s are required to undergo biometric authentication before initial onboarding and subsequent access to the platform.

The distinguishing features of the present technology include at least:
1. The use of blockchain technology to enhance transaction efficiencies and reduce trade-related costs.
2. The use of AI to automatically review and verify trade-related documents.
3. The use of digital signatures to make trade-related documents tamper-proof.

The present design ensures that payment is made once the transaction requirements/criteria are satisfied. It allows setting those criteria and other rules within the platform, such as those used for reviewing/analyzing documents by AI per above, based on global standards. The current technology enables moving money across international borders securely and transparently by utilizing blockchain technology.

The systems and apparatus of the present technology include a computer system comprising: (a) a decentralized and immutable ledger; (b) a letter of credit (LC) object stored in said decentralized and immutable ledger; (c) a plurality of documents related to said LC object uploaded to said computer system; (d) an artificial intelligence (AI) module for analyzing said plurality of documents and for ensuring their compliance with one or more requirements of said LC object; and (e) a non-custodial wallet for a buyer onboarded to said computer system, and a custodial wallet related to said LC object; wherein said computer system facilitates a payment from said custodial wallet to a seller in accordance with said requirements.

The systems and apparatus of the present design further include a computer system comprising: (a) a decentralized and immutable ledger; (b) a transaction object stored in said decentralized and immutable ledger; (c) a plurality of documents related to said transaction object uploaded to said computer system; (d) an artificial intelligence (AI) assistant for analyzing said plurality of documents and for ensuring their compliance with one or more requirements of said transaction object; and (e) a non-custodial wallet for a sender onboarded to said computer system, and a custodial wallet related to said transaction object; wherein said computer system facilitates a payment from said custodial wallet to a recipient in accordance with said requirements.

The methods of the present technology comprise the steps of: (a) creating a letter of credit (LC) object by a buyer onboarded to a computer system and storing said LC object in a decentralized and immutable ledger of said computer system; (b) uploading a plurality of documents related to said LC object to said computer system; (c) providing an artificial intelligence (AI) assistant for analyzing said plurality of documents and for ensuring their compliance with one or more requirements of said LC object; (d) implementing in said computer system, a non-custodial wallet for said buyer and a custodial wallet related to said LC object; and (e) facilitating a payment from said custodial wallet to a seller in accordance with said requirements.

Clearly, the system and methods of the invention find many advantageous embodiments. The details of the invention, including its preferred embodiments, are presented in the below detailed description with reference to the appended drawing figures.

### BRIEF DESCRIPTION OF THE DRAWING FIGURES

FIG. 1A shows a block diagram of a trade management/finance platform based on the instant principles.

FIG. 1B shows a general-purpose money-remittance workflow carried out through the trade management platform of FIG. 1A.

FIG. 2A-B present the left-hand and right-hand portions respectively of a UI screen showing the documents required by an LC in the system of FIG. 1A-B.

FIG. 3A-B show the left-hand and right-hand screen portions respectively of a delivery screen of the system of FIG. 1A-B.

FIG. 4A-B show the left-hand and right-hand screen portions respectively of a payment screen of the system of FIG. 1A-B.

FIG. 5A-B show the left-hand and right-hand screen portions respectively of an LC overview screen of the system of FIG. 1A-B.

FIG. 6A-B show the left-hand and right-hand screen portions respectively of an LC Timeline screen of the system of FIG. 1A-B with some tasks Pending and some Complete.

FIG. 7A-B show the left-hand and right-hand screen portions respectively of an updated LC Timeline screen of FIG. 6A-B with all the tasks Complete.

### DETAILED DESCRIPTION

The figures and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention (s), examples of which are illustrated in the accompanying figures. It is noted that wherever practicable, similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

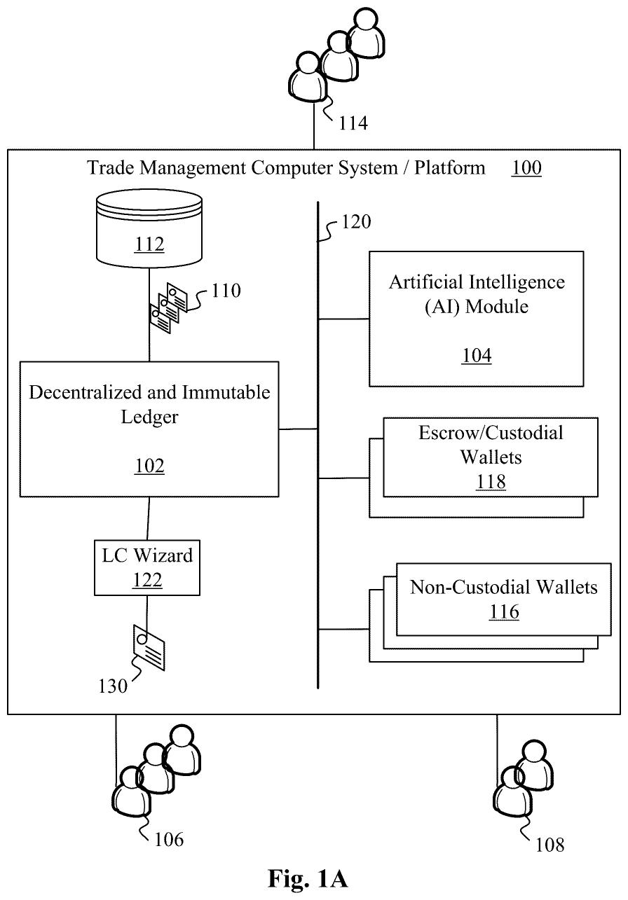

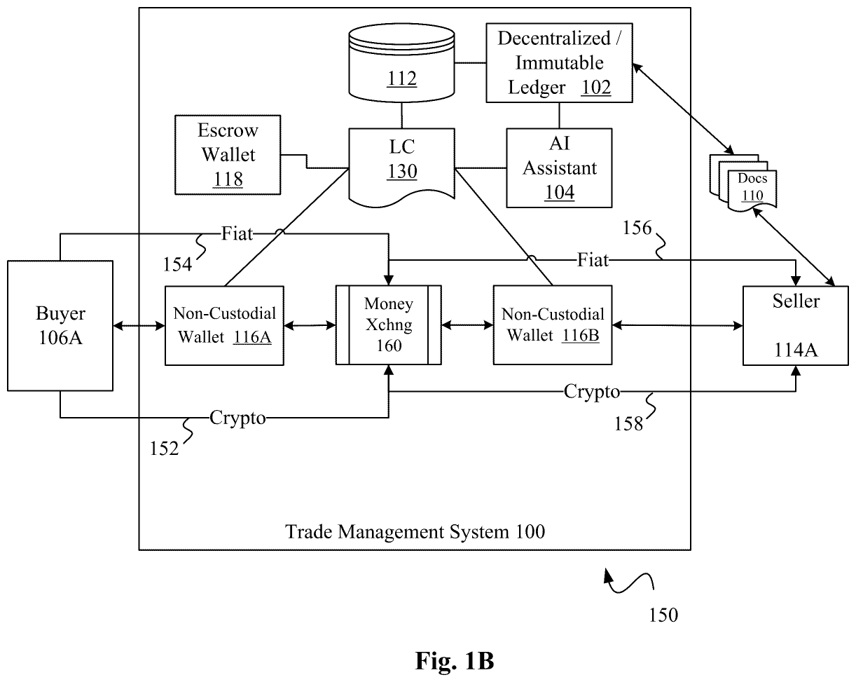

Let us now review an online global trade finance platform or an online global trade management computer system or a trade management computer platform or simply a computer system/platform 100 based on the present principles by taking advantage of FIG. 1A. FIG. 1A shows a trade management system/platform 100 comprising a number of subsystems and components operably connected to each other on a network 120. The various components of the instant or disclosed computer system or platform 100 include a decentralized or distributed and immutable ledger 102, an artificial intelligence (AI) module or assistant or agent 104, an LC wizard 122, one or more non-custodial wallets 116 and one or more escrow or custodial wallets 118.

Also shown are one or more registered and onboarded users 106 representing buyer users or simply buyers, as well as one or more registered users 108 representing the administrator users or simply administrators of computer system 100. Depending on the embodiment, there may also be one or more registered and onboarded buyer users or simply buyers 114 on trade management or trade finance system 100 as shown.

In the generalized embodiment of the present technology instant trade management platform 100 is used as a general-purpose multicurrency money remittance platform or system as will be discussed herein. In such a multicurrency money remittance system 100, registered and onboarded users 106 represent senders that are interested in sending payment (s) to their counterparties or recipients represented by registered and onboarded users 114 in accordance with specified escrow conditions.

Any number of such buyers or senders 106A, 106B, . . . , 106M (simply referred to as buyers/recipients 106) and sellers or recipients 114A, 114B, . . . , 114N (simply referred to as sellers/recipients 114) may be supported by system/platform 100. Administrators 108 are in charge of maintaining and ensuring a smooth operation of system 100. The administrators belong to the business entity, exemplarily Payco®, that owns and operates instant or disclosed computer system 100. Instant computer system 100 may be on-premise at Payco® or hosted in the cloud.

The most preferred embodiment of the present technology implements system 100 as a web application that can be accessed over the internet via a “thin” client such as a web browser. In such an embodiment, there is also preferably a mobile phone application of the present technology that allows a user access to instant computer system 100 via a mobile application or “App”. Exemplarily, the App is on an iOS device and can be downloaded from Apple™ App Store. Alternatively, the App is on an Android device and may be downloaded from the Android™ Store.

Let us first understand how trade management computer system 100 of the instant technology is used to facilitate a letter of credit (LC) transaction. According to the chief aspects, one of onboarded buyers/users 106, e.g. onboarded buyer user or simply buyer 106A, creates a letter of credit (LC) 130 in computer system 100 with the aid of LC wizard 122 as will be described further below. Further, the process of registering and onboarding a user on platform 100 will be discussed further below.

The purpose of creating an LC 130 is to pay for goods or services to a seller or a shipper or an exporter or the beneficiary. The seller is typically an overseas or international seller or an exporter although that is not a requirement. Conversely, the buyer can also be an overseas importer although that is not a requirement. First, a buyer, exemplarily buyer 106A, and a seller, exemplarily seller 114A, agree that the payment of goods/services will be done via an LC. Such an a priori agreement is often accomplished via in person meetings and/or phone calls and/or emails, prior to the use of present platform 100 of FIG. 1A.

User 106A creates LC object or simply LC 130 in system 100 by utilizing the appropriate graphical user interface (GUI) or more simply user interface (UI) screens associated with an LC wizard 122 of system 100. Wizard 122 is an instant module that guides users through sequence of the steps/tasks of creating/configuring and transacting LC 130 in system 100. The wizard screens simplify the process by breaking it down into a series of manageable steps. The GUI screens of system 100 will be discussed in detail further below. These screens guide user 106A to input or select the various fields of information required by the user to create and transact the LC.

As a part of the LC creation via LC wizard 122, user 106A enters or configures or selects the various documents 110 that will be required for the fulfillment of LC 130. Some of these documents are selected for LC 130 by default. There may also be additional documents that are recommended by the system and which the user can select from as they wish to be included in LC 130. Concomitantly with the creation of LC 130 or thereafter, one or more documents 110 required/stipulated by LC 130 are uploaded into system 100.

These documents are needed to satisfy the requirements of LC 130 and are uploaded by seller 114A and/or buyer 106A. If the seller is not an onboarded user, the required documents may be sent/emailed by the seller to one of administrators 108 who then subsequently uploads them into system 100. As will be discussed further below, a number of scenarios for supporting seller 114A are conceivable. These include when seller 114A is onboarded to platform 100 and accept the business entity owning and operating platform 100, exemplarily Payco®, as the financial intermediary, as well as when they are unwilling to do so and wish to process LC 130 through their own bank, among others.

As will be understood by those skilled in the art, an LC allows a trade of goods or services to occur so that the seller can be ensured of getting paid for the goods/services after they have been rendered/shipped. Conversely, the LC also allows the buyer to be ensured that the goods/service will be received once the payment of the transfer of money from the buyer has occurred.

For the above purpose, an LC object, or simply an LC, such as LC 130, is opened/created by buyer 106A in system 100. Thereafter, the LC object or LC is maintained or stored throughout its lifecycle in a decentralized or distributed and immutable ledger 102. In other words, LC 130 is recorded/saved into ledger 102 once it has been opened or created. Thereafter, any updates/changes to LC 130 are recorded in ledger 102 throughout the lifecycle of LC 130.

In a technical sense, it is the LC object along with its data structures and computer programming code that is stored in ledger 102. These data structures store various features/aspects of the LC in ledger 102, including but not limited to Date Opened/Created, Applicant Info, Requirements/Ts&Cs, Overall status and Status of each document. For brevity we will simply refer to such an LC object as an LC in this disclosure.

Instant decentralized and immutable ledger 102 is preferably based on blockchain technology. Depending on the requirements of LC 130, some of documents 110 are uploaded by buyer 106A while others may be uploaded by seller 114A associated with LC 130. Typical documents that may be required for this purpose include an airway bill, a certificate of origin, a certificate of liability insurance, a certification of sanitization, a clean report, and a bill of exchange or a draft instructing the buyer to pay a specified amount at a specific time as per the terms of the LC.

Once LC 130 has been created in trade management platform/system 100 of FIG. 1A per above, an LC contract is generated by the system for the two counterparties i.e. buyer 106A and seller 114A. Table 1 presents an exemplary LC contract generated/created by trade management platform 100. This sample contract was excerpted from the relevant screens of system 100. The LC contract lists the various documents required for the completion of transaction for LC 130.

TABLE 1
(Sample LC contract)
Letter of Credit Contract

The generated LC contract is shown to the right. You can download a
digitally signed version of this contract by clicking the button below.
Download Contract
LC Contract
To: Bishoy Mikhael (bishoy@payco.swiss)
From: Khaled Sharif (khaled@payco.swiss)
The following serves as a formal contract between ″Bishoy
Mikhael″, hereinafter referred to as the ″Seller,″ and ″Khaled
Sharif″, hereinafter referred to as the ″Buyer,″ regarding the
terms and conditions of a Letter of Credit (LC) transaction.
The Buyer agrees to establish an irrevocable Letter of Credit
(LC) in favor of the Seller for the Total Contract Value,
issued by The Pay Company AG, a licensed financial
intermediary based in Switzerland, hereinafter referred to as
″Payco″.
The LC shall be subject to the Uniform Customs and
Practice for Documentary Credits (UCP 600) as published
by the International Chamber of Commerce (ICC).
The Seller shall arrange for the shipment of the
Commodity/Product to the Buyer's designated port of entry
within a reasonable timeframe after the LC is established.
Return to LC
Payco Bishoy Mikhael
The Seller shall provide Payco with all necessary
documents, including but not limited to:
1. Beneficiary's Signed Commercial Invoice
2. Shipper Airway Bill Showing Applicant Name and Address
3. Certificate of Origin Issued by Beneficiary or Manufacturer
4. Insurance Policy Valid for 110% Value of Goods
The Buyer reserves the right to inspect and verify the
Commodity/Product upon arrival at the designated port of
entry. Any discrepancies or defects shall be communicated
to the Seller within a reasonable timeframe.
If the Commodity/Product does not conform to the
specifications outlined in this contract or is defective, the
Buyer may reject the shipment and request corrective action
or replacement. Upon receipt and acceptance of the
compliant shipment, Payco will release the payment as
stipulated in the LC to the Seller.
Any disputes arising from this contract shall be settled
amicably through negotiation between the parties. If no
resolution can be reached, the dispute shall be submitted to
mediation or arbitration.
This LC transaction and any dispute or claim arising out of
or in connection with it, including any question regarding its
existence, validity, or termination, shall be governed by and
construed in accordance with Swiss law.
The parties irrevocably agree that the courts of Switzerland
shall have exclusive jurisdiction to settle any disputes or
claims that arise out of or in connection with this LC
transaction or its subject matter or formation, including non-
contractual disputes or claims.
This contract represents the entire agreement between the
Buyer and the Seller regarding the Letter of Credit
Jan. 8, 24, 3:04 PM Payco https://payco.swiss/credit/
6595c48deec88ea7d6a702bd/contract2/3

Any documents 110 accompanying or required/stipulated for transacting/processing LC 130 are stored in a database storage 112 as shown in FIG. 1A. Database 112 can be an on-premise database or it can be a cloud storage, such as that available on AWS™ or another cloud storage provider. Regardless, when a document is saved/uploaded to platform 100 and more specifically to its decentralized/blockchain ledger 102 and database 112, its cryptographic signature or hash is also stored in ledger/database 102/112. Subsequently, whenever such a digitally protected document is accessed, its hash is recomputed and matched/verified against the one stored in ledger 102. A match of such a cryptographic or digital signature/hash each time the respective document in database 110 is accessed ensures that the document has not been modified or tampered with.

As will be understood by those skilled in the art, in a traditional LC transaction, there are also a number of banks involved. There is at least an issuing bank with whom the buyer (also referred to an applicant) first applies for an LC while providing the requisite documentation/documents. The issuing bank then performs know your customer (KYC) checks/verification of the applicant and evaluates their credit-worthiness and/or trust-worthiness. The bank further evaluates the submitted documents and if there are any deficiencies, the applicant is notified to overcome those.

Once and if the applicant qualifies, then an LC is opened on their behalf. The issuing bank may require for the buyer to make an upfront deposit of money towards the purchase amount specified in the LC. Conversely, there is also a nominating bank on the seller side that verifies the seller and evaluates any documents submitted by them. At the successful conclusion of an LC transaction, the stipulated amount of money is transferred via the banks as intermediaries from the buyer to the seller for the goods/services rendered.

A key contribution of the present design is that banks are no longer required between buyer 106A and seller 114A to transact an LC, such as LC 130. Instead, the business entity owning and operating instant platform, exemplarily Payco®, acts as the financial intermediary instant and trade management system/platform 110 facilitates the LC transaction. It does so directly rather than requiring an issuing or buyer bank and a nominating or seller bank.

Once LC 130 and its supporting documents 110 have been entered/uploaded in system 100, LC 130 is automatically evaluated by system 100 to ensure its compliance with the terms stipulated in the LC. For the above purpose of evaluating whether the submitted documents 110 are in compliance with the LC object e.g. LC 130, and more specifically its terms and conditions (Ts&Cs) or requirements, an artificial intelligence (AI) module or assistant 104 is employed. AI module/assistant/agent 104 checks the compliance of LC 130 by analyzing/reviewing the supporting documents 110.

In order to accomplish its objectives, AI module 104 utilizes a number of different techniques. These include but are not limited to natural language processing (NLP) and large language model (LLM) techniques. A preferred embodiment utilizes LayoutLM model/framework by Microsoft®. The same or a related embodiment utilizes PyTorch by Facebook®. The same or related embodiment utilizes Hugging Face™ for NLP. Additionally, AI module 104 may also employ optical recognition technologies (OCR) for reading documents in portable digital format (PDF) or any other formats.

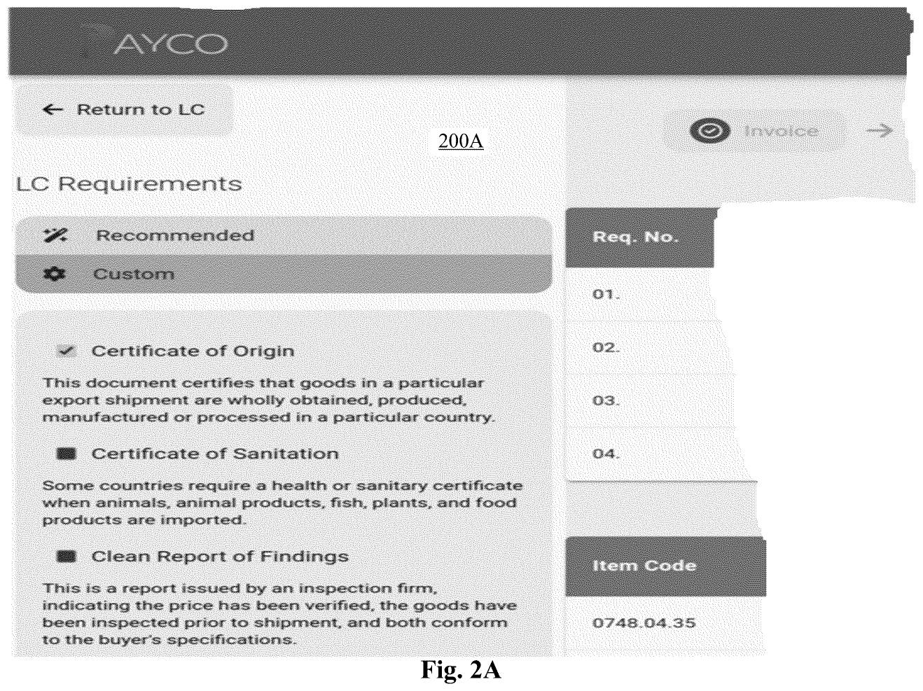

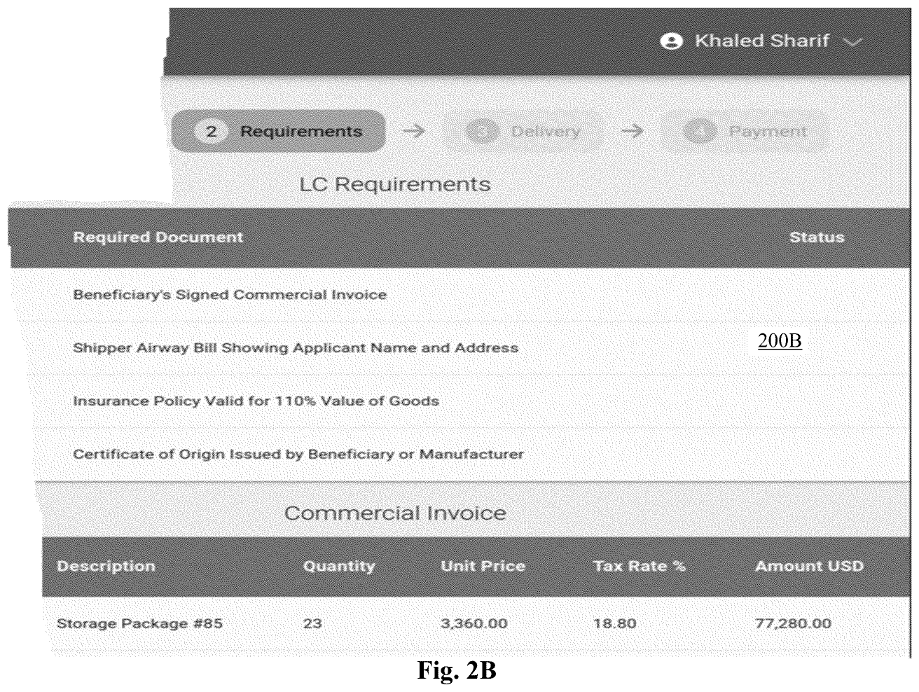

Based on the instant principles, AI module 104 analyzes the requirements for each party as configured for/in LC object 130 in system 100. More specifically, these requirements are specified in the LC object in system 100 and generated in the associated LC contract. An example of such an LC contract was provided in Table 1 above. Now, FIG. 2A and FIG. 2B show the left-hand portion 200A and right-hand portion 200B respectively of one of the UI screens of LC wizard 122 of system 100 showing the documents required by LC 130. More specifically, and as shown in the screen portions 200A-B of FIG. 2A-B, there are four documents that are required by shipper or seller 114A to upload into system 100. These documents are:
1. Beneficiary's Signed Commercial Invoice
2. Shipper Airway Bill Showing Applicant Name and Address
3. Insurance Policy Valid for 110% Value of Goods
4. Certificate of Origin Issued by Beneficiary or Manufacturer

Employing one or more of its above-mentioned technologies, AI module/assistant 104 first “reads” or understands the above requirements and the responsible party, in this case the shipper. In the preferred embodiment, the shipper or seller or exporter is also a registered and onboarded user, such as user 114A of system 100, however that is not a requirement as noted above. In such a preferred embodiment, shipper 114A simply uploads requisite documents 110 of LC 130 to or onto online global trade finance or trade management platform/system 100 and more specifically to its ledger 102 and to database 112.

As will be discussed in detail in the money remittance functionality of instant platform 100, it is possible that the shipper is not a registered user of the instant system. In such a scenario, instant computer system 100 may generate an email or a text message for the shipper with an upload link that allows them to upload the requisite documents to or onto system 100, without requiring registration. Of course, such a document uploaded by an unregistered shipper user is performed once the shipper passes the requisite know your customer (KYC) or other required checks.

Such checks may be mandated by instant platform 100 itself in addition to or in accordance with the applicable laws of the country of origin of the shipper as well as where instant platform is operating. The link in the text message or email may also invite the shipper to register and onboard platform 100. As shown in screen portion 200A of FIG. 2A, additional documents may also be recommended by system 100 to the user for including/inclusion into LC 130.

In any case, AI module 104 reads and comprehends the requirements of an LC. For our exemplary LC 130, four documents 110 were required of the shipper. AI module/assistant 104 analyzes each of the required documents 110 associated with LC 130 that have been uploaded to computer system 100. Based on its analysis, it determines if documents 110 are in compliance/conformance or otherwise in violation of the requirements of LC 130.

If AI assistant 104 determines that all of documents 110 stipulated in LC 130 have been uploaded and their contents satisfy the requisite requirements, then it marks the requirements of LC 130 in system 100 as Complete. Preferably, it marks the status of each uploaded document as Complete. In a variation, it also concomitantly sets the status of the LC as being Approved or Complete. On the other hand, if a required document is not uploaded yet, or is incomplete or has invalid contents, then its status is set to or kept as Pending (or Incomplete).

Explained further, AI module/assistant 104 determines if all the mandatory fields of the uploaded documents are filled out with valid data. Exemplarily, for LC 130, beneficiary's signed commercial invoice needs to have valid fields for the goods/services and their prices, as well as the signature of the shipper/beneficiary. Similarly, a shipper airway bill needs to have valid US or overseas address as applicable for the parties along with their legal names filled in. It further needs to have all the mandatory fields related to the transportation company/carrier fields filled in, in order to serve as a proper proof of shipment.

Similarly, the insurance policy needs to have the mandatory fields related to the insurance carrier filled in as well as the stipulated amount of coverage specified. In the above example of LC 130, the coverage amount is 110% of the value of goods as specified in the commercial invoice. Finally, for the example LC object or LC 130, the certificate of origin needs to be on proper paper/document and officially certified and/or stamped by relevant authorities to attest the requisite location/country where the goods have originated from or manufactured in. Exemplarily, if shipper 114A is in China, then the certificate of origin must officially indicate that.

AI module/assistant 104 is initially trained on a diverse dataset of related trade documents that enable it to analyze the contents of each of the documents per above. As noted, AI module 104 can utilize any one of the available and suitable technologies for its analysis, including LLM and LLP. If there are any discrepancies or deficiencies in the documents, AI module 104 detects those and flags them on relevant screens of system 100. In a preferred embodiment, AI module 104 denies or rejects the LC in system 100 based on those discrepancies/deficiencies. In an alternative embodiment, it notifies administrators 108 of these discrepancies/deficiencies who can then preferably notify the relevant party/parties to take corrective actions.

If the number and contents of all documents 110 uploaded to system 100 for LC object or LC 130 are satisfactory, this means that the seller has met all their obligations. This signifies that funds in escrow in system 100 can be released to seller 114A. More specifically, this means that the amount of payment specified in the commercial invoice document that is associated with LC object or simply LC 130 can be sent to seller 114A. Payment remittance capabilities of instant platform 100 will be discussed in detail further below.

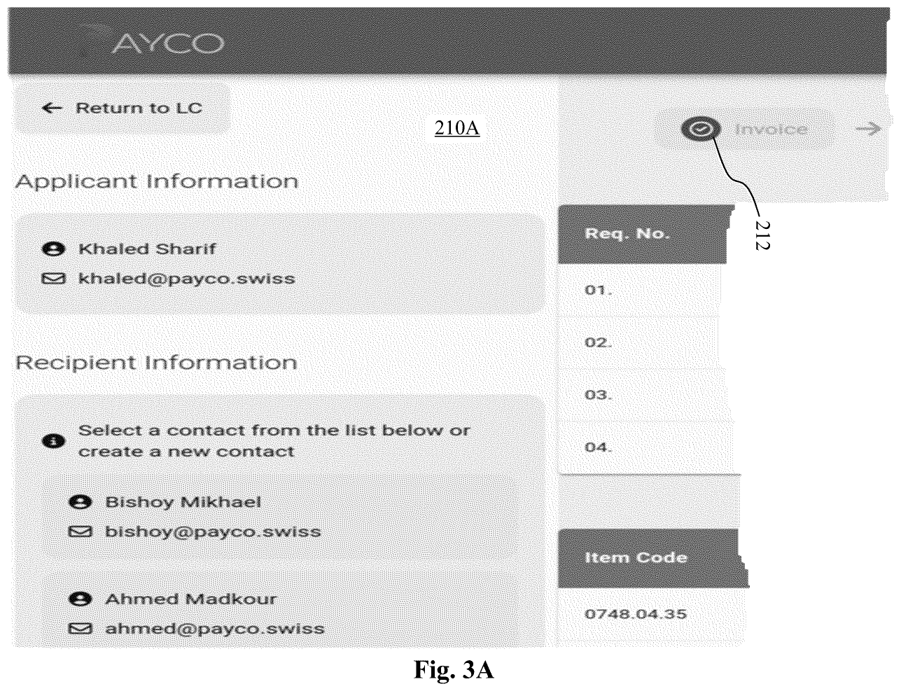

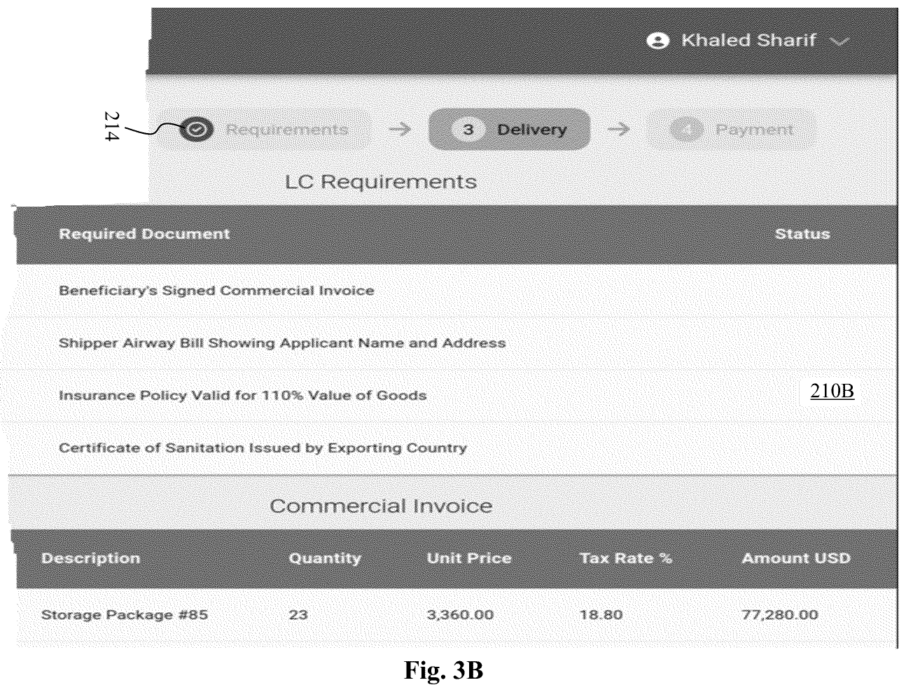

The delivery screen of LC wizard 122 for our exemplary LC 130 is shown by its left-hand and right-hand screen portions 210A and 210B of FIG. 3A and FIG. 3B respectively. Note by tick-mark 212 that the invoicing for LC 130 (as signified by beneficiary's signed commercial invoice per above) has been completed. Note by tick-mark 214 that all the documents required by LC 130 have been uploaded and their contents analyzed/reviewed to be satisfactory by AI module 104. This screen signifies to all parties that the goods have been shipped and buyer 106A can take possession of the goods once they arrive (per the airway bill above). This also signifies to system 100, that the payment to seller 114A can be made.

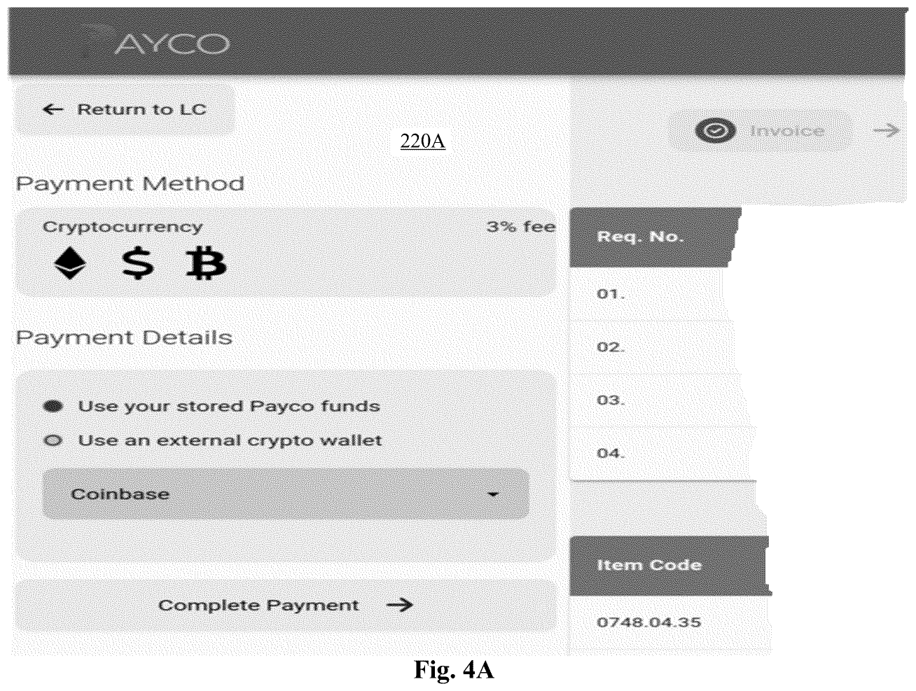

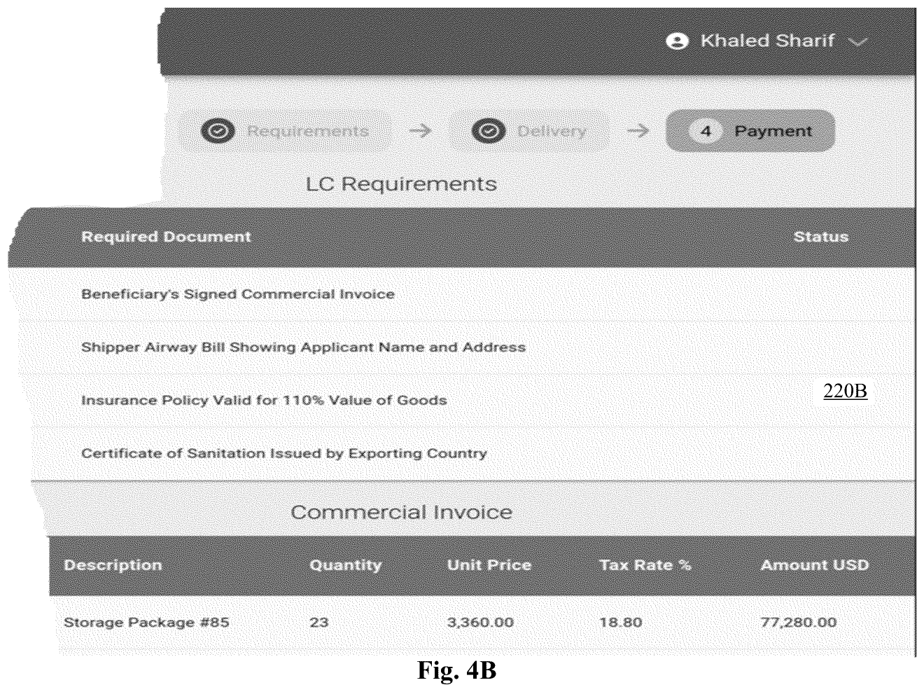

The payment screen of LC wizard 122 for our exemplary LC object or simply LC 130 is shown by its left-hand and right-hand screen portions 220A and 220B of FIG. 4A and FIG. 4B respectively. Note from screen portion 220A the various payment methods including the fiat and cryptocurrencies supported by instant platform 100. More specifically in the embodiment shown, US dollars as a fiat currency, and Bitcoin and Ethereum as cryptocurrencies are supported.

Let us now review additional samples of documents 110 for satisfying an exemplary LC in system 100 opened by a buyer/applicant also sometimes referred to as a consignee, such as buyer/applicant/consignee 106B. As was the case for LC 130 above, the first such document may be a commercial invoice. Table 2 provides an exemplary commercial invoice that may be uploaded by the corresponding shipper/seller, such as seller 114B to/into/onto computer system 100.

TABLE 2
(Sample Commercial Invoice by a Shipper/Exporter)

ABC Exporters Ltd.
456 Oak Street
Anytown, ABC 98765
Foreign Country
Phone: +123-456-7890
Email: info@abcexporters.com
Invoice Date: Jan. 15, 2024
Invoice Number: INV-2024-002
Buyer: XYZ Importers Ltd.
789 Oak Avenue
Othercity, NY 54321
United States
Shipping Date: Jan. 20, 2024
Shipment Method: Sea Freight
Port of Loading: Port ABC
Port of Discharge: Port XYZ

| Item Description | Quantity | Unit Price | Total Price |
|---|---|---|---|
| Product A | 100 | $12.00 | $1,200.00 |
| Product B | 150 | $18.50 | $2,775.00 |
| Product C | 75 | $22.00 | $1,650.00 |

| | |
|---|---|
| Subtotal: | $5,625.00 |
| Shipping & Handling: | $300.00 |
| Insurance: | $200.00 |
| Other Charges: | $150.00 |
| Total Amount: | $6,275.00 |

Terms of Payment: Payment against LC sight
LC Number: LC987654321
Bank: International Bank of Overseas
Bank Address: 123 Foreign Street, Anytown, ABC
SWIFT Code: IBOOFCUSXX

The second document may be a shipper's airway bill. The airway bill demonstrates that the goods have been received by the transport carrier from shipper 114B. Table 3 provides an example of such an airway bill.

TABLE 3
(Sample Airway Bill)
AIRWAY BILL

Shipper:
ABC Exporters Ltd.
456 Oak Street
Anytown, ABC 98765
Foreign Country
Phone: +123-456-7890
Consignee:
XYZ Importers Ltd.
789 Oak Avenue
Othercity, NY 54321
United States
AWB Number: AWB-2024-002
Flight Information: EK456—Emirates Flight
Departure Airport: Foreign Airport (ABC)
Destination Airport: JFK International Airport, New York (JFK)

Table 4 shows a sample certificate of origin. This document verifies the country in which goods were manufactured, produced, or processed.

TABLE 4
(Sample Certificate Of Origin)
CERTIFICATE OF ORIGIN

Exporter: ABC Exporters Ltd.
Address: 456 Oak Street, Anytown, ABC 98765, Foreign Country
Phone: +123-456-7890
Email: info@abcexporters.com
Importer: XYZ Importers Ltd.
Address: 789 Oak Avenue, Othercity, NY 54321, United States
Invoice Number: INV-2024-002
Export Reference: AWB-2024-002
Date of Issue: Jan. 25, 2024
Country of Origin: Foreign Country (e.g., ABC)
We, ABC Exporters Ltd., hereby certify that the goods described in
the attached invoice, namely Product A, Product B, and Product C,
were produced and manufactured in Foreign Country (ABC).
These goods comply with the origin requirements specified for
preferential treatment under the relevant free trade agreement
(if applicable).
CARRIER: ABC Air Cargo
PORT OF LOADING: Port ABC
PORT OF DISCHARGE: Port XYZ
FINAL DESTINATION: Othercity, NY 54321, United States
ETD: Jan. 30, 2024
ETA: Feb. 10, 2024
MARK(S) & NUMBERS ON PACKAGES: [Example Markings]
QUANTITY OR WEIGHT:
Product A—100 units
Product B—50 units
Product C—75 units
Signature: [Signature]
Name: John Doe
Title: Export Manager
Date: Jan. 25, 2024
Official Seal

Table 5 shows a sample insurance policy document as required to be submitted by shipper 114B.

TABLE 5
(Certificate of Insurance)
CERTIFICATE OF INSURANCE

Insured: ABC Exporters Ltd.
Address: 456 Oak Street, Anytown, ABC 98765, Foreign Country
Phone: +123-456-7890
Email: info@abcexporters.com
Insurance Company: XYZ Insurance Co.
Policy Number: POL-2024-001
Date of Issue: Jan. 25, 2024
To Whom It May Concern,
This is to certify that ABC Exporters Ltd. is covered under insurance
policy POL-2024-001 with XYZ Insurance Co. The insurance policy
provides coverage for goods shipped under Invoice Number INV-
2024-002 and corresponding AWB-2024-002 for 110% of the total
value of the goods being shipped.
The coverage includes, but is not limited to, risks of loss or damage
to the goods during transportation, subject to the terms and
conditions of the insurance policy.
This certificate is issued at the request of the insured for their
commercial transactions.
Sincerely,
[Signature]
[Name of Insurance Company Representative]
[Title or Position]
Date: [Date]

As mentioned, there may also be any additional documents 110 uploaded to or into or onto system 100 as required for the LC by shipper 114B and/or the buyer 106B and as required for a given implementation. Examples include a sanitization report by a shipper that confirms that the goods were property sanitized according to the applicable laws and rules prior to shipment. Another example is a clean report that confirms that goods prior to shipment were inspected and verified to be clean as per the applicable laws and rules.

In the preferred embodiment, ledger 102 is a distributed ledger implemented using the blockchain technology. Blockchain is a distributed ledger with an ever-growing list of blocks or records that are securely linked together via cryptographic hashes. Blocks are added based on a consensus utilizing a suitable consensus-based algorithm. Each block is identified by its cryptographic hash or block header hash or simply block hash. Each block also contains the hash of the previous block, as well as a date/timestamp and transaction data. The transaction data is generally represented as a Merkle tree, where data nodes are represented by leaves.

Since each block contains information about the previous block, they effectively form a chain, with each additional block linking to the previous block. As a result, blockchain transactions are immutable or irreversible in that, once they are recorded, the data in any given block cannot be altered retroactively without altering all subsequent blocks. Other types of distributed and decentralized ledgers that may be used in the implementation of the present design besides blockchain include among others, hashgraph, Tangle™, Holochain™, Ripple™ and Hyperledger Fabric™.

Let us now review the money remittance/transfer capabilities of the present technology in more detail. For transacting an LC, these capabilities are needed to transfer funds from the buyer to the shipper after the shipment of goods. As stated above, instant platform 100 can also be used as a general-purpose money transfer platform. In such a generalized embodiment, we will use the general term of a sender instead of a buyer and the general term of a recipient instead of shipper to signify that the money is transferred from the sender to the recipient.

In the generalized money transfer/remittance, unlike an LC object, there is a generalized transaction object that is created and stored in ledger 102 and database 112. The generalized transaction object is used to track the flow of funds from sender to recipient. Analogously to an LC object, the transaction object also contains the conditions or requirements or Ts&Cs of escrow. Once those requirements are satisfied, funds can be released from the escrow to the recipient. Rest of the relevant capabilities of an LC object associated with LC trade finance taught above, also apply to such a transaction object. These include tracking and recording the transaction object throughout its lifecycle and along with the associated/uploaded documents from/by sender and recipient in an instant distributed ledger/database.

To facilitate money transfer, instant computer system 100 also implements one or more non-custodial or non-escrow wallets 116, one for each registered/onboarded user. A non-custodial wallet 116 is where the user stores their money in the instant platform. The respective user has full access to their non-escrow wallet 116 including having access to all its cryptographic or master keys. In the above LC example, buyer 106A and seller 114A onboarded to platform 100 would thus each have non-custodial wallets 116A and 116B respectively per FIG. 1A.

In addition, and as needed, the instant platform also implements or creates a custodial or escrow wallet 118 for each transaction and more specifically for each transaction object (or an LC object for the LC embodiments above). This is where the instant platform holds money on behalf of a party “in escrow” or in custody, until the conditions stipulated in the escrow for the release of funds have been satisfied. When used as a money-remittance platform, the Ts&Cs or requirements of an LC, such as LC 130 discussed in the example above, are generalized to escrow Ts&Cs required for release of funds to the recipient.

Implementing a separate escrow wallet 118 for each transaction allows the instant platform to segregate funds as required by the rules of compliance. When a transaction/LC object is first opened/created by buyer, an initial deposit in a partial amount or the full invoice amount as specified in the above-explained commercial invoice may be required to be deposited by sender/buyer 106A in wallet 118. The initial deposit may take the form of an electronic payment or any other type of payment as discussed herein. From thereon, instant platform 100 holds those funds in escrow or custody until the fulfillment of all the requirements of the LC as explained herein.

### User Onboarding:

User registration and onboarding is accomplished using the following steps:
1. User accesses instant online trade management/finance platform 100 on its hosted website over a web browser or a mobile application. The user then registers on the website/mobile app and opens a user account via sign-up or registration UI screens of the website or mobile application. This is referred to as user registration.
   In a highly preferred variation, biometric authentication is used by instant platform 100 for initially registering and then logging in users.
   Such biometric authentication includes and is not limited to:
      a. Fingerprint Recognition
      b. Iris Recognition
      c. Retina Scanning
      d. Facial Recognition
      e. Voice Recognition
      f. Palm Print Recognition
      g. Hand Geometry Recognition
      h. Signature Recognition
      i. Keystroke Dynamics
      j. Ear Recognition
      k. DNA Matching
      l. Gait Recognition, among others.
2. Once registered, the user is required to pass a know your business (KYB) or know your customer (KYC) check in order to use the money remittance services or other services provided by the instant platform. Such a verification check may be outsourced by the instant platform to an appropriate service provider, exemplarily KYC Spider, among others.
3. Once the above verification checks are passed, the user is considered onboarded, and a non-custodial digital wallet 116 shown in FIG. 1A is created for the user in instant platform 100. If the user has an “external” wallet with another virtual asset service provider (VASP), the external wallet may be whitelisted during the onboarding process. An exemplary VASP may be Coinbase™. This whitelisting allows the user to use their external wallet for holding their funds while still being able to use the services offered by the instant platform.

### Fiat Out (Fiat Payment to a Recipient):

Per above teachings, AI assistant/module 104 of FIG. 1A analyzes the requirements associated with a transaction. In the context of a generalized money-remittance service, these requirements will be stored in the data structures of the associated transaction object (or of an LC object for the LC embodiments above). Per above, the transaction (or LC) object is stored in distributed ledger/database 102/112. Therefore, AI assistant 104 will read and “understand” the requirements in the transaction object including any documents that are uploaded. It will then analyze the documents to ensure their validity, and then mark each requirement as Complete or Pending as applicable per above.

Once the above requirements, or in other words, the conditions for the release of funds specified in escrow wallet 118 associated with a transaction have been satisfied, instant platform 100 of FIG. 1A transfers the specified funds to the recipient.

If the recipient has chosen to be paid in fiat currency, the instant platform first converts the requisite amount of crypto currency in escrow wallet 118 to obtain the required amount of fiat currency in its bank account to be paid to the recipient. The instant platform can make such a fiat payment to the recipient in at least the following ways:
1. If the recipient, exemplarily shipper 114A, is already onboarded to the platform via the User Onboarding process provided above, the fiat currency is sent from the bank account of the instant platform with a banking partner, to the bank account of the recipient. More specifically, the bank account would be in the name of the business entity owning and operating instant platform, exemplarily Payco®. For the above purpose, the recipient would have entered their banking information into the instant platform using appropriate UI screens, along with instructions to payout their fiat money into their bank account.
2. If the recipient is not a registered user, the instant platform sends a link (or another form of invitation) to the recipient to sign up on the platform. The link or invitation may be received by the recipient over email, a text message, exemplarily an iMessage or short message service (SMS) message, any or over other forms of communication. Using the link, the recipient can register and onboard via the User Onboarding steps provided earlier, and then enter their banking information into the instant platform, and the rest of the flow continues as per step (1) above.
   However, if the recipient does not wish to onboard the instant platform, or do not have technological means/resources to access the platform, they can send their International Bank Account Number (IBAN) number to the instant platform and more specifically to an administrator 108. Instant platform then checks the IBAN against any sanctions or if the IBAN has been blacklisted. For this purpose, the instant platform preferably utilizes an outsourced IBAN verification service.
   If the recipient IBAN is cleared, then the instant platform transfers the specified fiat funds from its bank account to the recipient's IBAN account. In the case of an LC transaction, this scenario is performed when seller/shipper 114A is unwilling to use Payco® as the financial intermediary and instead wish to process LC 130 through their own bank.

### Crypto Out (Crypto Payment to a Recipient):

Per above teachings, AI assistant/module 104 of FIG. 1A analyzes the requirements associated with a transaction. In the context of a generalized money-remittance service, these requirements will be stored in the data structures of the associated transaction object (or of an LC object for the LC embodiments above). Per above, the transaction (or LC) object is stored in distributed ledger/database 102/112. Therefore, AI assistant 104 will “understand” the requirements in the transaction/LC object including any documents that are uploaded. It will then analyze the documents to ensure their validity, and then mark each requirement as Complete or Pending as applicable per above.

Once the above requirements, or in other words, the conditions for the release of funds specified in escrow wallet 118 associated with a transaction have been satisfied, the Instant platform of FIG. 1A transfers the specified funds to the recipient. If the recipient has chosen to be paid in cryptocurrency, the instant platform can make such a crypto payment to the recipient in at least the following ways:
1. If the recipient is already onboarded to instant platform via the User Onboarding process provided above, then the instant platform transfers the crypto from escrow wallet 118 to non-custodial wallet 116 of the recipient, exemplarily wallet 116B of shipper 114A.
   The recipient may now utilize/dispose of the received crypto in their non-custodial wallet 116B as desired, for example, send crypto to another user, exchange crypto into crypto or fiat, and the like.
2. If the recipient is not a registered user, the instant platform sends a link (or another form of invitation) to the recipient to sign up on the platform. The link or invitation may be received by the recipient over email, a text message, exemplarily an iMessage or short message service (SMS) message, or over other forms of communication. Using the link, the recipient can register and onboard via the User Onboarding steps provided earlier, and the rest of the flow continues per step 1 above.

Let us now consider various scenarios depending on the form of payment between sender 106, such as buyer 106A of the above example, and recipient 114, such as shipper 114A of the above example. Recall, the instant platform may be used as a general-purpose multicurrency money transfer or exchange platform. The money remittance functionality of the present design is greatly suited to various business use-cases including performing an LC transaction.

Therefore, in the money transfer/exchange scenarios below as applied to an LC transaction, the user sending the money or sender would evidently be the buyer, such as buyer 106A of FIG. 1A and the user receiving the money or recipient will be the seller, such as seller 114A of FIG. 1A. Let us now review these scenarios in detail in concert with FIG. 1A presented earlier, as well as FIG. 1B. FIG. 1B specifically illustrates money-remittance workflow 150 by utilizing the embodiment of FIG. 1A presented earlier. FIG. 1B specifically shows non-custodial wallets 116A and 116B for users 106A and 114A per above discussion. Network 120 of FIG. 1A is not explicitly shown in FIG. 1B to avoid clutter.

### Crypto In, Crypto Out:

In this scenario, both the sender and the recipient wish to transact in the form of a virtual or cryptocurrency, exemplarily Bitcoin (BTC), Ethereum (ETH), US Dollar Pegged Stable Coin (USDP/USDC), Decentralized Stable Coin (DAI), amongst others. This scenario is depicted by directed lines 152 and 158 in FIG. 1B.
1. The sender enters the following information on an appropriate UI screen of the instant platform:
   a. The name, telephone number, and/or email and/or any other identifying information of the recipient.
   b. The type of crypto to be sent, exemplarily BTC, ETH, USDC, DAI, amongst others.
   c. The amount of crypto to be sent.
   d. Any conditions/stipulations for release of funds from the escrow and more specifically from escrow wallet 118 to the recipient.
2. The instant platform transfers the requisite amount of crypto from non-custodial wallet 116 (or an external wallet) of sender to escrow wallet 118 associated with this transaction in instant platform 100 of FIG. 1A-B. The platform performs any requisite cryptocurrency conversion from the type of cryptocurrency of non-custodial wallet 116A to the required type of cryptocurrency specified for the transaction. For this purpose, the instant platform preferably utilizes a banking partner and such a conversion may incur fees. This conversion/exchange/transfer step is shown by subroutine or process box or block 160 in FIG. 1B.
1. Now, once the conditions stipulated in the escrow are satisfied, the crypto payment is made to the recipient as provided under the section heading “Crypto Out (Crypto Payment to a Recipient)” above. This crypto payment is made to the recipient to their non-custodial wallet 116B of FIG. 1B, provided they are an onboarded user per above teachings.

### Crypto In, Fiat Out:

2. This scenario is depicted by directed lines 152 and 156 in FIG. 1B. It begins with the sender entering the following information on an appropriate UI screen of the instant platform:
   a. The name, telephone number, and/or email and/or any other identifying information of the recipient.
   b. The type of crypto to be sent, exemplarily BTC, ETH, USDC, DAI, amongst others.
   c. The amount and type (i.e. USD, GBP, Euros, etc.) of fiat currency to be sent.
   d. Any conditions/stipulations for release of funds from the escrow i.e. from escrow wallet 118 to the recipient.
3. The sender sends crypto from their non-custodial wallet 116A (or an external wallet) to escrow wallet 118 associated with this transaction in instant platform 100 of FIG. 1A-B.
3. The instant platform exchanges the crypto amount in escrow wallet 118 associated with the transaction into the fiat currency specified by the sender above. This is accomplished by the instant platform by utilizing a banking partner, that may be a traditional bank that supports the exchange of the cryptocurrency in question. In other words, the instant platform 100 provides the requisite amount of crypto currency (based on the prevalent exchange rate at the time of the transaction) from escrow wallet 118 to obtain the fiat currency into its bank account with the banking partner. The amount and type of fiat currency is what is specified by the sender for the recipient per above. The above conversion/exchange/transfer step is shown by subroutine or process box or block 160 in FIG. 1B.
4. Now, once the conditions stipulated in the escrow are satisfied, the fiat payment is made to the recipient as provided under the section heading “Fiat Out (Fiat Payment to a Recipient)” above.

### Fiat In, Crypto Out:

1. This scenario is depicted by directed lines 154 and 158 in FIG. 1B. It begins with the sender entering the following information on an appropriate UI screen of the instant platform:
   a. The name, telephone number, and/or email and/or any other identifying information of the recipient.
   b. The type (e.g. USD, GBP, Euros, etc.) and amount of fiat currency that the sender is sending, and the type (BTC, ETH, USDC, DAI, amongst others) and amount of crypto they wish to be sent to the recipient.
   c. Any stipulations for the release of funds from the escrow.
2. The sender transfers the specified amount of fiat currency from their bank account or credit card to the instant platform bank account with its banking partner. Such a transfer may take the form of a Wire or an automated clearing house (ACH) transaction, or an electronic payment utilizing Paypal™ or Venmo™ or a similar money transfer service. The instant platform converts this fiat currency into a cryptocurrency and stores it into non-custodial wallet 116A of the sender. In the preferred embodiments, the cryptocurrency that fiat currency of the sender is converted into is a “stable” cryptocurrency that is pegged to a fiat currency.
   The preferred stable currency chosen by the instant platform is USDP or USDC, however, the sender is given the option of specifying any supported cryptocurrency, including BTC, ETH, DAI, amongst others for conversion. The sender can make this choice when they are transferring the fiat currency to the platform. Instant platform 100 preferably uses cryptocurrency exchange services provided by its banking partner for the above conversion and which is based on the prevalent exchange rate at the time of the transaction.
   The instant platform then transfers the requisite amount of crypto from non-custodial wallet 116A of the sender obtained above, to an escrow wallet 118 associated with the transaction. The platform performs any requisite cryptocurrency conversions as needed for this purpose. For example, if the default cryptocurrency of the non-custodial wallet of the sender is USDP and they wish to pay the recipient in BTC, then the instant platform will do such a conversion, preferably using its business partner and which incur fees. Regardless, at this stage the requisite amount and type of cryptocurrency is stored in escrow wallet 118 that is associated with the transaction. The above conversion/exchange/transfer step is shown by subroutine or process box or block 160 in FIG. 1B.
5. Now, once the conditions stipulated in the escrow are satisfied, the crypto payment is made to the recipient as provided under the section heading “Crypto Out (Crypto Payment to a Recipient)” above. This crypto payment is made to the recipient to their non-custodial wallet 116B provided they are an onboarded user per above teachings.

### Fiat In, Fiat Out:

1. This scenario is depicted by directed lines 154 and 156 in FIG. 1B. It starts with the sender entering the following information on an appropriate UI screen of the instant platform:
   a. The name, telephone number, and/or email and/or any other identifying information of the recipient.
   b. The type (e.g. USD, GBP, Euros, etc.) and amount of fiat currency that the sender is sending to the recipient.
   c. Any stipulations for the release of funds from the escrow.
2. The sender transfers the specified amount of fiat currency from their bank account or credit card to the instant platform bank account with its banking partner. As per Step 2 of Fiat In, Crypto Out scenario noted above, the instant platform obtains an equivalent amount of cryptocurrency into non-custodial wallet 116 of the sender.
   The instant platform then transfers the requisite amount of crypto from the non-custodial wallet 116A of the sender obtained, to an escrow wallet 118 associated with the transaction. The above conversion/exchange/transfer step is shown by subroutine or process box or block 160 in FIG. 1B.
3. Now, once the conditions stipulated in the escrow are satisfied, the fiat payment is made to the recipient as provided under the section heading “Fiat Out (Fiat Payment to a Recipient)” above.

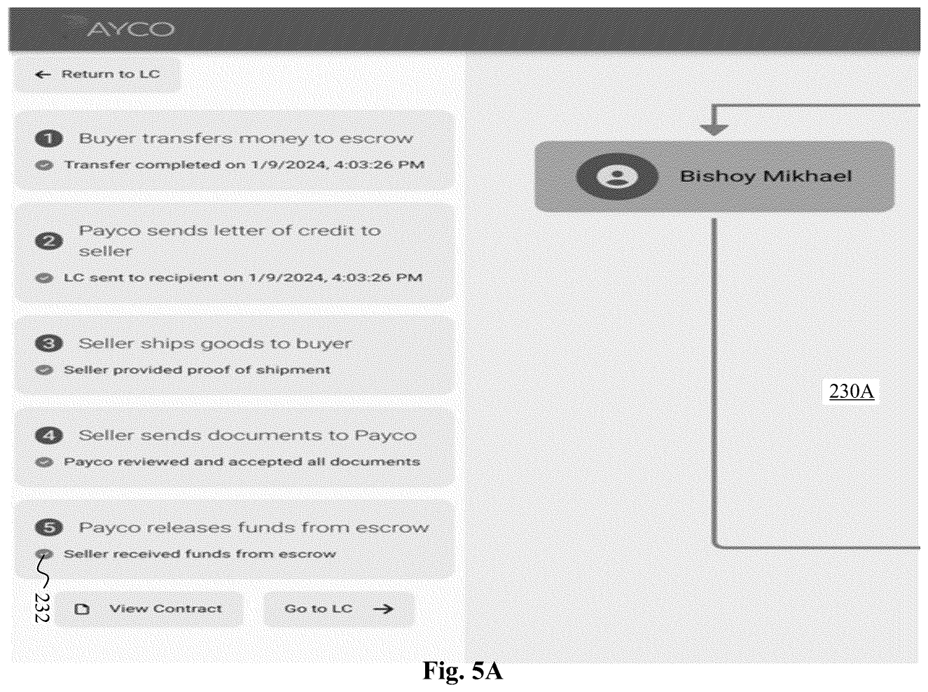

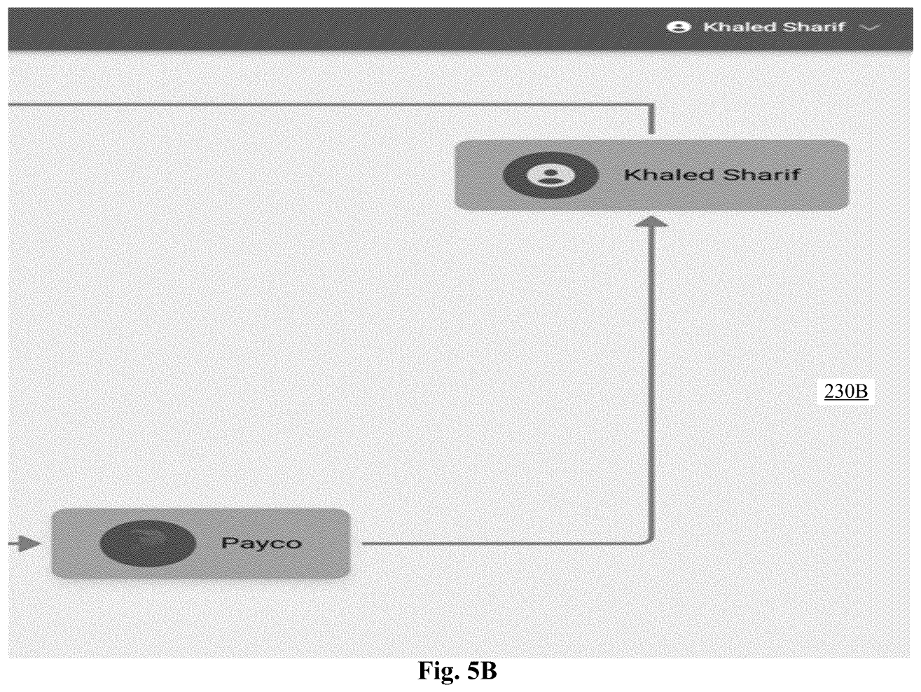

After having described the general-purpose money remittance capabilities of the instant platform, let us now turn our attention back to the use-case of performing LC transactions by using the instant technology. For this purpose, let us now review the left-hand and right-hand portions 230A and 230B of an LC Overview screen of instant platform 100 of FIG. 1 as shown in FIG. 5A and FIG. 5B respectively. In the example shown in FIG. 5, note by the tick-mark symbols, such as one shown by reference numeral 232, the status of various tasks of the LC as Complete.

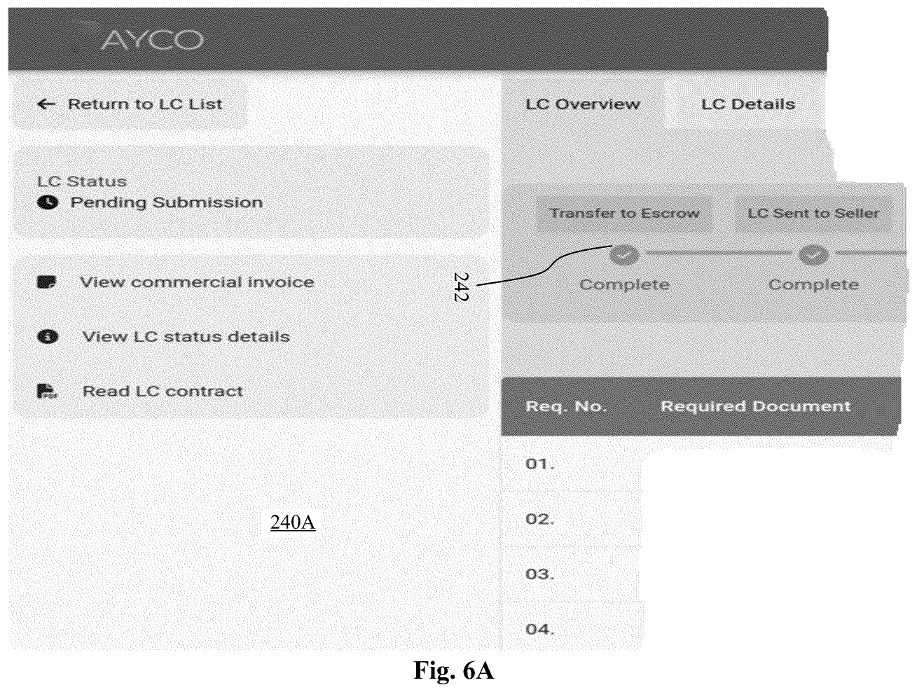

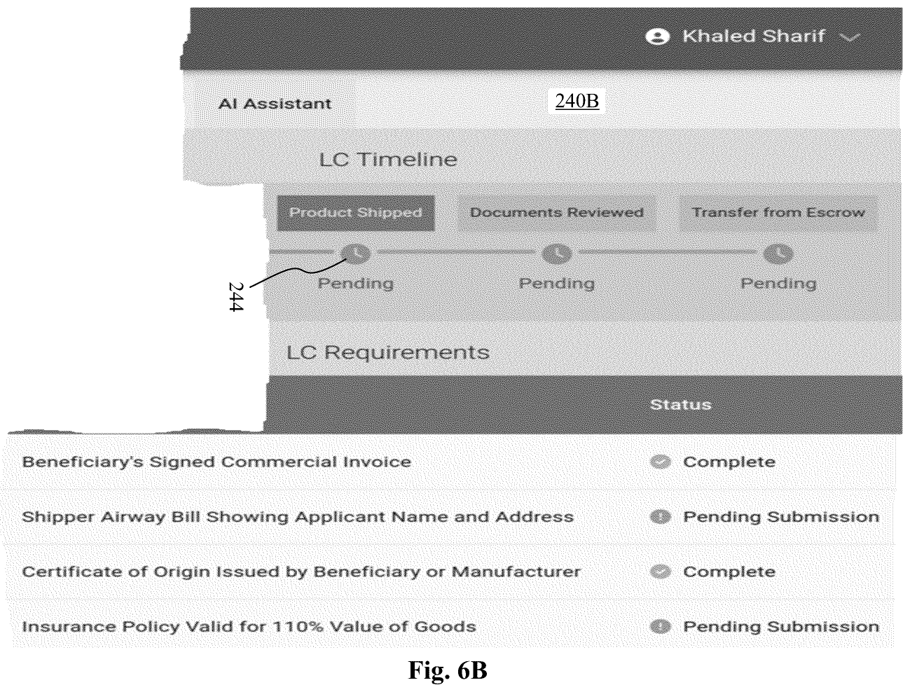

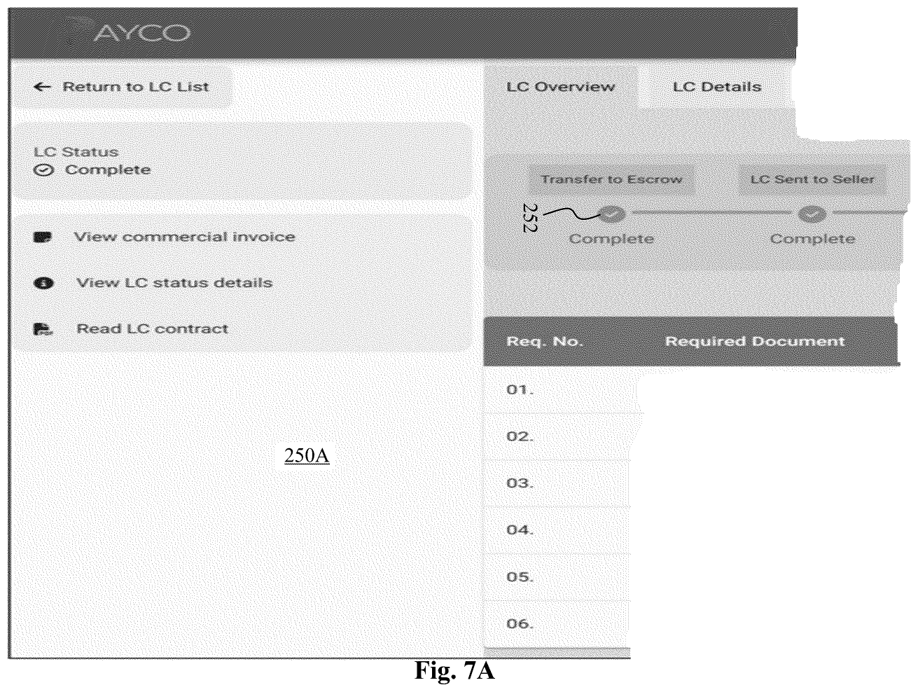

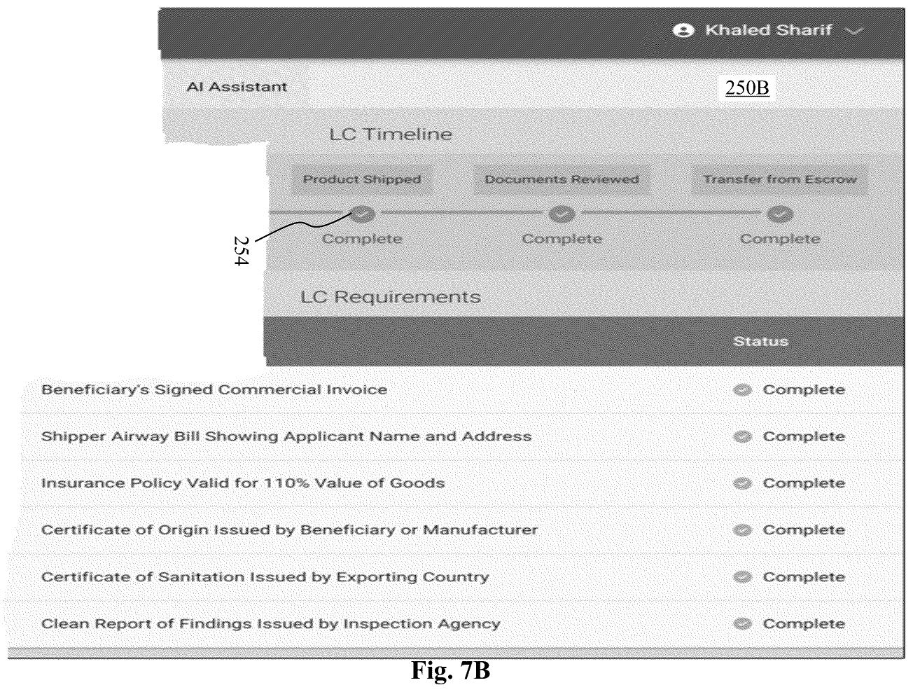

The left-hand and right-hand portions 240A and 240B of an LC Timeline screen of instant platform 100 of FIG. 1A-B is shown in FIG. 6A and FIG. 6B respectively. In the example shown in FIG. 6, note by the tick-mark symbols, such as one shown by reference numeral 242, and the clock symbols, such as one shown by reference numeral 244, the status of various tasks of the LC as either Complete or Pending respectively. The same example is shown in the LC Timeline screen shown by its left-hand portion 250A in FIG. 7A and right-hand portion 250B in FIG. 7B. Notice in FIG. 7, that the step/task “Product Shipped” now has a tick-mark 254 signifying its status as Complete.

The present technology streamlines and modernizes the process of issuing and processing LCs by leveraging blockchain technology and artificial intelligence (AI) technologies. Traditional methods of handling an LC involve a cumbersome and time-consuming paper trail, leading to inefficiencies, delays, and a heightened risk of errors. The present design addresses these shortcomings by digitizing the entire process. Blockchain technology is employed to create an immutable ledger that records the status of the LC, providing transparency, security, and traceability throughout the transaction lifecycle. The instant platform employs centralized and decentralized currency exchanges to facilitate seamless international transactions with favorable commission rates and quick settlement times.

Blockchain technology is used to write and store the LC information in a tamper-proof and decentralized ledger. This ledger ensures that the status and details of the LC are securely maintained and can be accessed by relevant parties in real-time. As explained above, an AI module/assistant plays a key role during the document submission phase, where it analyzes the submitted documents for compliance with the LC requirements. The AI module/assistant can automatically Approve or Deny an LC processing request based on predefined criteria, reducing the need for manual intervention and expediting the overall process.

The blockchain and AI components/modules/technologies are seamlessly integrated into the instant online global trade finance platform. The blockchain utilizes a consensus mechanism that ensures the security and integrity of the ledger. Instant technology is preferably implemented on a blockchain platform with due consideration to transaction speeds, consensus algorithms and security protocols. The AI module preferably employs machine learning models and algorithms that are trained on a diverse dataset to accurately assess document compliance.

Alternative embodiments include integrating additional layers of security, such as biometric authentication, to enhance identity verification. As noted, the AI module/assistant preferably uses NLP for better document understanding. Extensions of the present technology include adapting the system for other financial instruments beyond LCs and broadening its applicability within the financial services industry. As a whole, the present design provides a flexible framework that can be adapted to specific use cases and extended to addressing the evolving needs of the digital finance realm.

In view of the above teachings, a person skilled in the art will recognize that the methods of present invention can be embodied in many different ways in addition to those described without departing from the principles of the invention. Therefore, the scope of the invention should be judged in view of the appended claims and their legal equivalents.

What is claimed is:

1. A computer system comprising:
(a) a decentralized and immutable ledger;
(b) a letter of credit (LC) object stored in said decentralized and immutable ledger;
(c) a plurality of documents related to said LC object uploaded to said computer system;
(d) an artificial intelligence (AI) module for analyzing said plurality of documents and for ensuring their compliance with one or more requirements of said LC object; and
(e) a non-custodial wallet for a buyer onboarded to said computer system, and a custodial wallet related to said LC object;
wherein said computer system facilitates a payment from said custodial wallet to a seller in accordance with said requirements.

2. The computer system of claim 1, wherein said decentralized and immutable ledger is based on blockchain technology.

3. The computer system of claim 1, wherein one or more of said plurality of documents are tamper-proofed by employing digital signatures.

4. The computer system of claim 1, wherein said AI module utilizes one or both of natural language processing (NLP) and a large language model (LLM) for said analyzing.

5. The computer system of claim 4, wherein said AI module marks a status of a document as one of Complete and Pending based on said analyzing, said document amongst said plurality of documents.

6. The computer system of claim 1 wherein said seller is also onboarded to said computer system, and further comprising a non-custodial wallet for said seller.

7. The computer system of claim 6 requiring biometric authentication from one or both of said buyer and said seller before allowing access to said computer system.

8. The computer system of claim 1, wherein said payment is made in one of a fiat currency and a cryptocurrency.

9. The computer system of claim 3, wherein said payment is made to an international bank account number (IBAN) of said seller.

10. A computer system comprising:
a) a decentralized and immutable ledger;
(b) a transaction object stored in said decentralized and immutable ledger;
(c) a plurality of documents related to said transaction object uploaded to said computer system;
(d) an artificial intelligence (AI) assistant for analyzing said plurality of documents and for ensuring their compliance with one or more requirements of said transaction object; and
(e) a non-custodial wallet for a sender onboarded to said computer system, and a custodial wallet related to said transaction object;
wherein said computer system facilitates a payment from said custodial wallet to a recipient in accordance with said requirements.

11. The computer system of claim 10, wherein said decentralized and immutable ledger is based on blockchain technology.

12. The computer system of claim 10, wherein said AI module utilizes one or both of natural language processing (NLP) and a large language model (LLM) for said analyzing.

13. A computer-implemented method comprising the steps of:
(a) creating a letter of credit (LC) object by a buyer onboarded to a computer system and storing said LC object in a decentralized and immutable ledger of said computer system;
(b) uploading a plurality of documents related to said LC object to said computer system;
(c) providing an artificial intelligence (AI) assistant for analyzing said plurality of documents and for ensuring their compliance with one or more requirements of said LC object;
(d) implementing in said computer system, a non-custodial wallet for said buyer and a custodial wallet related to said LC object; and
(e) facilitating a payment from said custodial wallet to a seller in accordance with said requirements.

14. The computer-implemented method of claim 13 implementing said decentralized and immutable ledger based on blockchain technology.

15. The computer-implemented method of claim 13 ensuring tamper-proofing of one or more of said plurality of documents by employing digital signatures.

16. The computer-implemented method of claim 13, wherein said AI module utilizes one or both of natural language processing (NLP) and a large language model (LLM) for said analyzing.

17. The computer-implemented method of claim 13 further comprising the steps of:
(f) onboarding said seller to said computer system; and
(g) implementing a non-custodial wallet for said seller in said computer system.

18. The computer-implemented method of claim 17 requiring biometric authentication from one or both of said buyer and said seller before allowing access to said computer system.

19. The computer-implemented method of claim 13, wherein said payment is in one of a fiat currency and a cryptocurrency.

20. The computer-implemented method of claim 13 making said payment to an international bank account number (IBAN) of said seller.
